(19) United States
(12) Patent Application Publication
(10) Pub. No.: US 2016/0348606 A1
(43) Pub. Date: Dec. 1, 2016

(54) CONTROL APPARATUS FOR INTERNAL COMBUSTION ENGINE

(71) Applicant: Toyota Jidosha Kabushiki Kaisha, Toyota-shi Aichi-ken (JP)

(72) Inventor: Kotaro Suzuki, Minamiashigara-shi Kanagawa-ken (JP)

(21) Appl. No.: 15/162,200

(22) Filed: May 23, 2016

(30) Foreign Application Priority Data
May 25, 2015 (JP) 2015-105641

(51) Int. Cl. F02D 41/30; F02D 41/26; F02D 37/02; F02B 5/02; F02D 41/00

(52) U.S. Cl. CPC F02D 41/3094; F02B 5/02; F02D 41/0007; F02D 37/02; F02D 41/26; F02D 2041/389

(57) ABSTRACT

In a spark-ignition internal combustion engine including a port injection valve that injects fuel into an intake port and an in-cylinder injection valve that injects fuel directly into a combustion chamber, switching from a first combustion mode which realizes lean combustion with an air-fuel ratio that is leaner in fuel than a theoretical air-fuel ratio and which is constituted mainly by fuel injection by the port injection valve, to a second combustion mode which realizes lean combustion by fuel injection in an intake stroke by the in-cylinder injection valve is enabled while maintaining a low amount of NOx emissions. The control device for an internal combustion engine of this disclosure makes a discharge time period of a spark plug in the second combustion mode longer than a discharge time period in the first combustion mode.

### CROSS-REFERENCE TO RELATED APPLICATIONS

The present application claims priority to Japanese Patent Application No. 2015-105641 filed May 25, 2015, which is herein incorporated by reference in its entirety include the specification, drawings and abstract.

### BACKGROUND

Field of the Application

The present application relates to a control apparatus for a spark-ignition internal combustion engine equipped with an in-cylinder injection valve and a port injection valve, and more particularly to a control apparatus for an internal combustion engine that is capable of lean combustion at an air-fuel ratio that is leaner in fuel than a theoretical air-fuel ratio.

Background Art

In the aforementioned field of the application, studies are being conducted with respect to enlarging an operating region in which lean combustion is performed to thereby improve the fuel consumption performance of internal combustion engines. Lean combustion is broadly divided into two kinds of combustion, namely, so-called “stratified lean combustion” in which combustion is performed by forming an air-fuel mixture layer with a high fuel concentration at the periphery of a spark plug, and so-called “homogeneous lean combustion” in which air and fuel are homogeneously mixed by premixing and then combusted. Homogeneous lean combustion can be further divided into two combustion modes according to the method used to realize the combustion. A first combustion mode is a mode that realizes homogeneous lean combustion by using only fuel injection that is performed by a port injection valve, or by using a combination of fuel injection by a port injection valve and fuel injection in an intake stroke by an in-cylinder injection valve. A second combustion mode is a mode that realizes homogeneous lean combustion by using only fuel injection that is performed in an intake stroke by an in-cylinder injection valve.

Of the above described two combustion modes, the combustion mode that can mix fuel and air more homogeneously and realize uniform combustion is the first combustion mode in which a longer time period can be taken for premixing of fuel and air. However, in a high torque region, the valve timing of an intake valve is advanced in order to raise the air intake efficiency, and as a result a valve overlap amount between an intake valve and an exhaust valve increases. In some cases, valve overlapping in a high torque region causes the occurrence of blow-by of air from an intake port to an exhaust port (so-called “scavenging”). In particular, in an internal combustion engine with a supercharger, the intake air pressure is boosted by supercharging, and the occurrence of scavenging is noticeable. If scavenging occurs when the first combustion mode is selected, a part of the fuel inside the intake port flows to the exhaust port together with the air, and there is thus a deterioration in both fuel consumption performance and emissions performance.

In this regard, in JP2005-133632A, technology is described in which the use of the aforementioned two combustion modes is selected according to the existence or non-existence of blow-by of fuel that accompanies valve overlapping. More specifically, according to the technology disclosed in JP2005-133632A, during a period in which non-permissible blow-by of fuel is not occurring, port injection and in-cylinder fuel injection in an intake stroke is performed (that is, the first combustion mode is selected), and in a case where it is determined that non-permissible blow-by of fuel is occurring, only in-cylinder fuel injection in the intake stroke is performed (that is, the second combustion mode is selected). According to the second combustion mode, because fuel is directly injected into the combustion chamber by an in-cylinder injection valve, an outflow of unburned fuel to the exhaust port that is caused by the blow-by of fuel is suppressed.

### SUMMARY OF THE APPLICATION

In this connection, in comparison to in-cylinder fuel injection in a compression stroke that is used in stratified lean combustion, the mixed state of fuel and air is brought closer to a homogeneous state by in-cylinder fuel injection in an intake stroke that is used in the second combustion mode. However, in comparison to port injection that is used in the first combustion mode, because a time period for premixing of fuel and air is short, the fuel concentration in the air-fuel mixture is liable to be uneven. Therefore, there is the possibility that, at the ignition timing, the fuel concentration at the periphery of a spark plug will be locally lower than the overall fuel concentration. If the fuel concentration at the periphery of a spark plug is overly low, there is a risk that ignition will not be possible, and this will lead to the occurrence of a torque level difference due to misfiring as well as a deterioration in the emissions performance.

One method for ensuring ignitability is a method that makes an air-fuel ratio in the second combustion mode relatively richer in fuel than an air-fuel ratio in the first combustion mode, while maintaining the air-fuel ratio at a ratio that is leaner in fuel than the theoretical air-fuel ratio. According to this method, even if the fuel concentration of an air-fuel mixture inside a combustion chamber is uneven, the occurrence of a situation in which the fuel concentration of the air-fuel mixture is partially so low that ignition cannot be performed is prevented. However, in engine operation that is performed by means of lean combustion, if the air-fuel ratio deviates to the rich side by even a small amount, the amount of NOx emissions will increase in proportion to the amount of deviation.

The present application addresses the above-described problem, and an object of the present application is to provide a control apparatus for an internal combustion engine that can switch from a first combustion mode which realizes lean combustion with an air-fuel ratio that is leaner in fuel than a theoretical air-fuel ratio and which is constituted mainly by fuel injection by a port injection valve, to a second combustion mode which realizes the lean combustion by means of fuel injection in an intake stroke by an in-cylinder injection valve, while maintaining a low amount of NOx emissions.

A control apparatus for an internal combustion engine according to the present disclosure is applied to an internal combustion engine equipped with a port injection valve that injects fuel into an intake port, an in-cylinder injection valve that injects fuel directly into a combustion chamber, and a spark plug. Combustion modes that are selectively executed by the present control apparatus include a first combustion mode which realizes lean combustion with an air-fuel ratio that is leaner in fuel than a theoretical air-fuel ratio and which is constituted mainly by fuel injection by the port injection valve, and a second combustion mode which realizes the lean combustion by means of fuel injection in an intake stroke by the in-cylinder injection valve. The term “constituted mainly by fuel injection by the port injection valve” refers to performing only fuel injection by the port injection valve, or combining fuel injection by the port injection valve and fuel injection by the in-cylinder injection valve but in a manner in which a fuel injection amount of the port injection valve is made larger than a fuel injection amount of the in-cylinder injection valve. In the first combustion mode, fuel injection by the port injection valve may be performed, or a combination of fuel injection by the port injection valve and fuel injection in an intake stroke by the in-cylinder injection valve may be used. In some embodiments, fuel injection by the port injection valve is a so-called “asynchronous injection” in which fuel injection is performed in a period in which an intake valve is closed.

The present control apparatus is configured so as to make a discharge time period of the spark plug in the second combustion mode longer than a discharge time period in the first combustion mode. In comparison to port injection that is mainly used in the first combustion mode, according to the in-cylinder fuel injection in the intake stroke that is used in the second combustion mode, the fuel concentration of the air-fuel mixture is liable to be uneven because a time period for premixing fuel and air is short. However, since an air-fuel mixture that is inside a combustion chamber is flowing, if the discharge time period is lengthened, the probability that a portion of the air-fuel mixture at which the fuel concentration is high will be positioned in the vicinity of the spark plug during the discharge time period is raised and thus the ignitability improves. That is, according to the present control apparatus, ignitability in the second combustion mode is ensured without resorting to correction of the air-fuel ratio to a fuel-rich side. Thus, switching from the first combustion mode to the second combustion mode is performed while maintaining a low amount of NOx emissions.

A discharge time period of the spark plug in the second combustion mode may be made longer than a discharge time period in the first combustion mode, and a discharge current value of the spark plug in the second combustion mode may be made less than a discharge current value in the first combustion mode. By this means, an increase in power consumption that is caused by lengthening the discharge time period is suppressed. The discharge current value may be adjusted according to the discharge time period so that the discharge energy is kept at a constant amount with respect to both the first combustion mode and the second combustion mode.

The internal combustion engine to which the present control apparatus is applied may be an internal combustion engine with a supercharger. In such a case, the present control apparatus may be configured so that, when a requested torque with respect to the internal combustion engine is larger than a maximum torque that is generated in the first combustion mode, the control apparatus increases a valve overlap amount between an intake valve and an exhaust valve to an amount that is greater than a valve overlap amount in the first combustion mode, and together therewith also switches from the first combustion mode to the second combustion mode. According to this configuration, homogeneous lean combustion is maintained without generating blow-by of fuel by switching to the second combustion mode, while improving the torque response by increasing the valve overlap amount. Naturally, in this case also, by making the discharge time period of the spark plug longer than the discharge time period in the first combustion mode upon switching to the second combustion mode, ignitability is ensured in a state in which unevenness arises in the fuel concentration of the air-fuel mixture.

As described above, according to the control apparatus for an internal combustion engine of the present disclosure, since ignitability in the second combustion mode is ensured without resorting to correction of the air-fuel ratio to a fuel-rich side, switching from the first combustion mode to the second combustion mode is performed while maintaining a low amount of NOx emissions.

### BRIEF DESCRIPTION OF THE DRAWINGS

FIG. 1 is a view illustrating the system configuration of an internal combustion engine according to an embodiment of the present disclosure;

FIG. 2 is a view illustrating a relation between combustion modes and the torque and engine speed;

FIG. 3 is a flowchart illustrating control logic of the embodiment of the present disclosure;

FIG. 4 is a time chart illustrating operations of the system according to the control logic of the embodiment of the present disclosure;

FIG. 5 is a view illustrating a relation between a discharge time period in a second combustion mode, an ignitable air-fuel ratio and a NOx emissions amount; and

FIG. 6 is a view for describing an effect of the control logic of the embodiment of the present disclosure.

### DETAILED DESCRIPTION OF THE EMBODIMENT

An embodiment of the present disclosure is described hereunder with reference to the accompanying drawings. However, it is to be understood that even when the number, quantity, amount, range or other numerical attribute of an element is mentioned in the following description of the embodiment, the present disclosure is not limited to the mentioned numerical attribute unless it is expressly stated or theoretically defined. Further, structures or steps or the like described in conjunction with the following embodiment are not necessarily essential to the present disclosure unless expressly stated or theoretically defined.

### [1. System Configuration of Internal Combustion Engine]

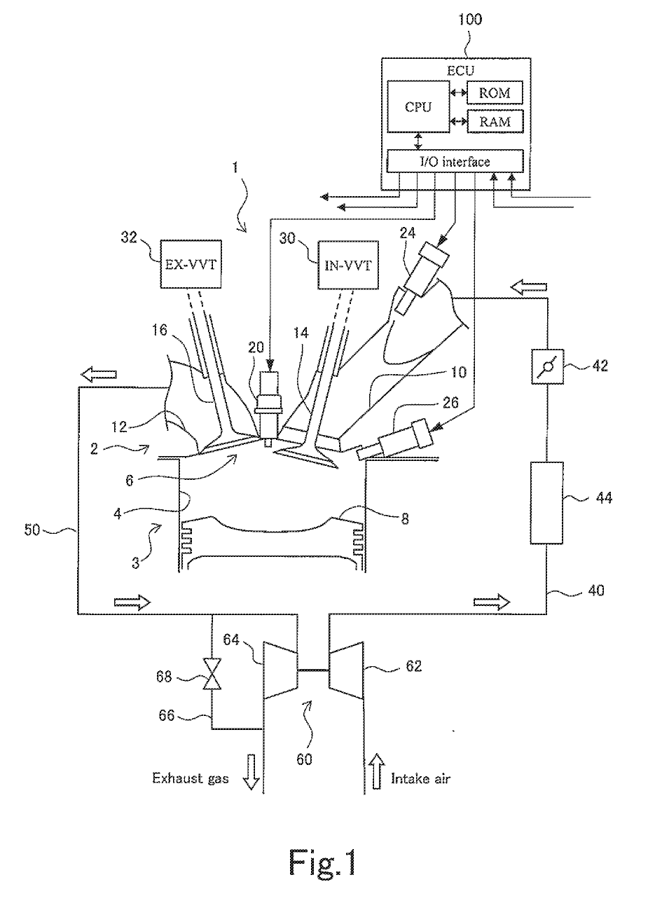

FIG. 1 is a view that schematically illustrates the system configuration of an internal combustion engine according to the present embodiment. In FIG. 1, components constituting the internal combustion engine 1 are illustrated in a manner in which the components are projected onto a single plane that is perpendicular to a crankshaft. The internal combustion engine 1 according to the present embodiment is a spark-ignition multi-cylinder engine (hereunder referred to simply as “engine”) that has a plurality of cylinders 4. The number and arrangement of the cylinders 4 is not limited. The engine 1 includes a cylinder block 3 in which the cylinders 4 are formed, and a cylinder head 2 that is arranged via an unshown gasket on the cylinder block 3. In each of the cylinders 4, a piston 8 is arranged that reciprocates in the axial direction thereof A pent-roof shaped combustion chamber 6 that is an upper space of the cylinder 4 is formed on the underside of the cylinder head 2. A spark plug 20 is provided in the vicinity of the top portion of the combustion chamber 6.

An intake port 10 and an exhaust port 12 that communicate with the combustion chamber 6 are formed in the cylinder head 2. An intake valve 14 is provided at an opening portion that communicates with the combustion chamber 6 of the intake port 10. An exhaust valve 16 is provided at an opening portion that communicates with the combustion chamber 6 of the exhaust port 12. A variable valve timing device (IN-VVT) 30 that varies a valve opening characteristic of the intake valve 14, and a variable valve timing device (EX-VVT) 32 that varies a valve opening characteristic of the exhaust valve 16 are provided in the cylinder head 2. A known valve mechanism that varies at least a valve timing can be applied as these variable valve timing devices.

Although not illustrated in the drawings, the intake port 10 bifurcates partway along its length in the direction from an inlet formed in a side face of the cylinder head 2 towards the opening portion that communicates with the combustion chamber 6. A port injection valve 24 that injects fuel into the intake port 10 is provided upstream of a portion at which the intake port 10 bifurcates. At a lower part of the intake port 10, that is a position between the bifurcating parts of the intake port 10, an in-cylinder injection valve 26 that injects fuel into the combustion chamber 6 is provided so that a distal end thereof faces the combustion chamber 6.

The engine 1 is a turbo-engine in which a turbocharger 60 is mounted. The turbocharger 60 includes a compressor 62 that is arranged in an intake passage 40 that is connected to the intake port 10, and a turbine 64 that is arranged in an exhaust passage 50 that is connected to the exhaust port 12. A bypass passage 66 is provided that bypasses the turbine 64. A waste gate valve 68 is provided in the bypass passage 66. An intercooler 44 and a throttle valve 42 are provided downstream of the compressor 62 in the intake passage 40. An unshown three-way catalyst and a NOx purification catalyst are provided downstream of the turbine 64 in the exhaust passage 50.

The engine 1 includes a control apparatus 100 for controlling the operations thereof. The control apparatus 100 is an ECU (electronic control unit) that includes at least an input/output interface, a ROM, a RAM and a CPU. The input/output interface is provided in order to take in sensor signals from various sensors installed in the engine 1 and a vehicle in which the engine 1 is mounted, and to also output actuating signals to actuators that the engine 1 includes. The sensors include a crank angle sensor, an accelerator opening degree sensor, an air-fuel ratio sensor, a combustion pressure sensor, an air flow sensor, an intake air pressure sensor, and a supercharging pressure sensor (none of which are illustrated in the drawings). The actuators include the port injection valve 24, the in-cylinder injection valve 26, an ignition apparatus including the spark plug 20, the throttle valve 42, the waste gate valve 68 and the variable valve timing devices 30 and 32. Various control programs for controlling the engine 1 and various kinds of control data including maps are stored in the ROM. The CPU reads out a control program from the ROM and executes the control program, and generates actuating signals based on sensor signals that are taken in.

### [2. Selection of Combustion Mode]

The control apparatus 100 calculates a requested torque in accordance with a depression amount of an accelerator pedal. The control apparatus 100 then selects a combustion mode of the engine 1 based on the requested torque and the current engine speed, and determines control parameters relating to operation amounts in accordance with the selected combustion mode.

FIG. 2 is a view that illustrates a relation between combustion modes of the engine 1 that are selected by the control apparatus 100, and the torque (TRQ) and the engine speed (Ne). As shown in FIG. 2, the combustion region of the engine 1 is divided into three regions. A combustion mode of the engine 1 is set for each region. A first combustion mode and a second combustion mode among the combustion modes of the engine 1 are modes that perform lean combustion with an air-fuel ratio that is leaner in fuel than a theoretical air-fuel ratio. In contrast, the third combustion mode is a mode that performs stoichiometric combustion with the theoretical air-fuel ratio.

In the first combustion mode, lean combustion is realized by a combination of fuel injection by the port injection valve 24 and fuel injection by the in-cylinder injection valve 26. The air-fuel ratio in the first combustion mode is set to a value of, for example, around 26. A sharing ratio with respect to sharing injection of fuel between the fuel injection by the port injection valve 24 and fuel injection by the in-cylinder injection valve 26 is set to a ratio from 100:0 to 50:50. That is, only fuel injection by the port injection valve 24 may also be used. In some embodiments, the fuel injection performed by the port injection valve 24 is a asynchronous injection that is performed in a period in which the intake valve 14 is closed. However, the fuel injection performed by the port injection valve 24 may be synchronous injection in which at least one portion of a period in which the intake valve 14 is open and the fuel injection period overlap. The fuel injection by the in-cylinder injection valve 26 is an intake stroke injection that is performed in the intake stroke.

In the case of fuel injection by the port injection valve 24 (particularly, asynchronous injection), a longer time period is taken from fuel injection until ignition, that is, a longer time period can be taken for premixing of fuel and air. Hence, when the first combustion mode is selected, fuel and air is homogeneously mixed to realize uniform combustion. However, there is a limit to the amount of torque that can be realized by lean combustion. Further, in a case where scavenging occurs, fuel that is injected by the port injection valve 24 is blown by to the exhaust port 12 together with air. Due to these restrictions, a combustion region in which the first combustion mode can be selected is limited as shown in FIG. 2.

In the second combustion mode, lean combustion is realized using only fuel injection in an intake stroke by the in-cylinder injection valve 26. That is, the sharing ratio with respect to fuel injection by the port injection valve 24 and fuel injection by the in-cylinder injection valve 26 is set to 0:100. In comparison to the combustion region in which the first combustion mode is selected, a combustion region in which the second combustion mode is selected is set to a side of a relatively higher torque and lower speed. The combustion region in which the second combustion mode is selected is also a combustion region in which scavenging is actively generated to raise the torque response. The amount of blow-by air that is caused by scavenging (scavenging amount) is determined by a valve overlap amount between the intake valve 14 and the exhaust valve 16 and a pressure difference between the pressure of the intake port 10 (intake air pressure) and the pressure of the exhaust port 12 (exhaust pressure). Switching from the first combustion mode to the second combustion mode is performed at a time that a requested torque for the engine 1 becomes equal to or greater than a first threshold torque Ta. The first threshold torque Ta is a maximum torque in a range within which blow-by of fuel due to scavenging does not occur. Since this is a parameter that changes depending on an engine speed Ne, the first threshold torque Ta is associated with the engine speed Ne in a map.

Since fuel injection by the in-cylinder injection valve 26 is performed directly into the combustion chamber 6, the influence of scavenging thereon is small in comparison to fuel injection by the port injection valve 24. When the scavenging amount is large, the occurrence of a situation in which unburned fuel flows from the combustion chamber 6 to the exhaust port 12 can be prevented by performing fuel injection by the in-cylinder injection valve 26 after the exhaust valve 16 closes. However, a time period from injection of fuel until ignition thereof is short in the case of the intake stroke injection by the in-cylinder injection valve 26 in comparison to port injection. Thus, the fuel concentration of the air-fuel mixture inside the combustion chamber 6 is liable to become uneven because a time period for premixing is not adequately secured.

The sharing ratio between port injection and in-cylinder injection is not the only control parameter that differs between the second combustion mode and the first combustion mode. Although a single point ignition system is adopted in both of the second combustion mode and the first combustion mode, when the second combustion mode is selected a discharge time period per single discharge of the spark plug 20 is made longer than a discharge time period in the first combustion mode. Since the air-fuel mixture is flowing inside the combustion chamber 6, if a long discharge time period is set, the probability that a high-fuel-concentration portion of the air-fuel mixture will be positioned in the vicinity of the spark plug 20 during the discharge time period is raised. Even if the fuel concentration of the air-fuel mixture is uneven, if a high-fuel-concentration portion of the air-fuel mixture comes to the spark plug 20 within the discharge time period, there is a high probability that the air-fuel mixture will be ignited. Therefore, when the second combustion mode is selected, there is no necessity to make the air-fuel ratio relatively richer in fuel compared to the first combustion mode. The air-fuel ratio in the second combustion mode is maintained at the same air-fuel ratio as the air-fuel ratio in the first combustion mode, or is set to almost the same air-fuel ratio.

Further, when the second combustion mode is selected, a discharge current value of the spark plug 20 is made less than a discharge current value in the first combustion mode. If it is desired to simply improve the ignitability, it is sufficient to merely adopt a long discharge time period. However, in such a case the power consumption required for ignition increases and the fuel consumption deteriorates. Therefore, in order to suppress an increase in the power consumption that is caused by adopting a long discharge time period, the discharge current value is reduced so that the discharge energy per single discharge is kept at a constant amount with respect to both the first combustion mode and the second combustion mode. The discharge start timing is kept constant with respect to both the first combustion mode and the second combustion mode. However, a configuration may be adopted so as to keep the discharge end timing constant, or to keep the center of the discharge period constant. Note that, technology for controlling a discharge time period and a discharge current value is known, as disclosed, for example, in JP2012-167665A or JP2010-261395A.

In the third combustion mode, stoichiometric combustion is realized by fuel injection in the intake stroke by the in-cylinder injection valve 26. A combustion region in which the third combustion mode is selected is set to a relatively higher torque side compared to the combustion regions in which the first combustion mode or second combustion mode is selected. Switching from the first combustion mode or the second combustion mode to the third combustion mode is performed at a time that a requested torque for the engine 1 becomes equal to or greater than a second threshold torque Tb. The second threshold torque Tb is a maximum torque within a range which can be realized by lean combustion. Since this is a parameter that changes depending on the engine speed Ne, the second threshold torque Tb is associated with the engine speed Ne in a map.

### [3. Control Logic of System]

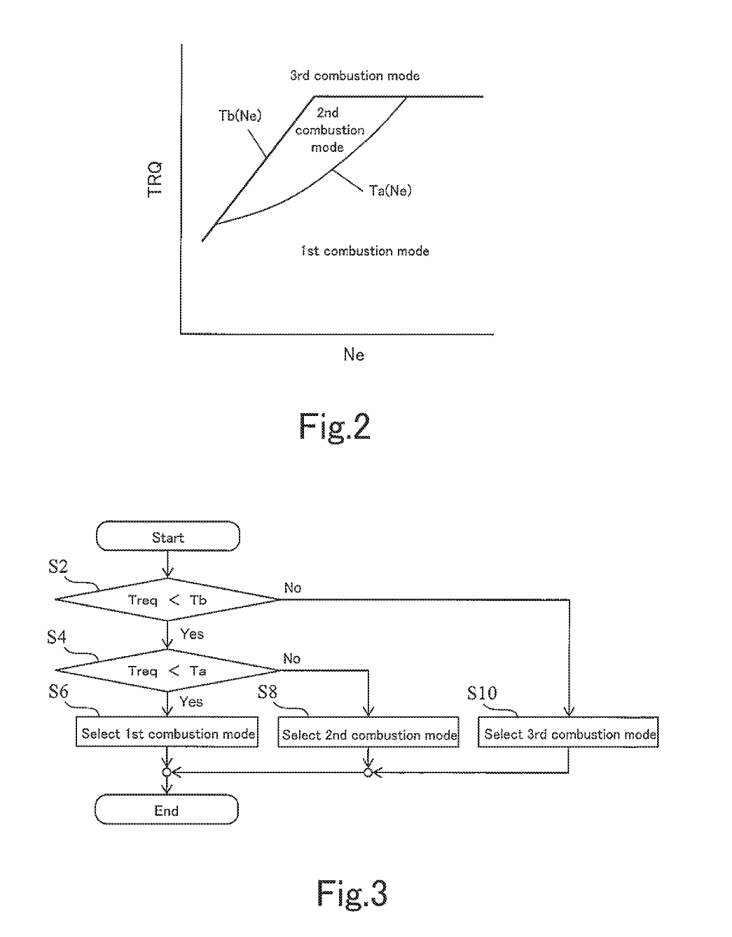

FIG. 3 is a flowchart that illustrates control logic of the system. The control apparatus 100 repeatedly executes a routine that is based on this control logic at predetermined control periods that correspond to the clock speed of the ECU.

In step S2, the control apparatus 100 determines whether or not a requested torque Treq for the engine 1 is less than the second threshold torque Tb. The second threshold torque Tb is determined based on the engine speed by referring to a map.

If the requested torque Treq is less than the second threshold torque Tb, in step S4 the control apparatus 100 determines whether or not the requested torque Treq for the engine 1 is less than the first threshold torque Ta. The first threshold torque Ta is determined based on the engine speed by referring to a map.

If the requested torque Treq is less than the first threshold torque Ta, in step S6 the control apparatus 100 selects the first combustion mode as the combustion mode of the engine 1. In a case where the first combustion mode is selected, homogeneous lean combustion is performed by combined use of fuel injection by the port injection valve 24 and fuel injection by the in-cylinder injection valve 26 (or by using only fuel injection by the port injection valve 24).

If the requested torque Treq is equal to or greater than the first threshold torque Ta and less than the second threshold torque Tb, in step S8 the control apparatus 100 selects the second combustion mode as the combustion mode of the engine 1. In a case where the second combustion mode is selected, lean combustion is performed using only fuel injection by the in-cylinder injection valve 26. Although lean combustion that is realized in the second combustion mode is inferior with respect to the homogeneity of the air-fuel mixture during combustion in comparison to the lean combustion that is realized in the first combustion mode, in actuality the lean combustion realized in the second combustion mode can be categorized as homogeneous lean combustion since the homogeneity of the air-fuel mixture during combustion is high in comparison to stratified lean combustion that is realized by compression stroke injection. In a case where the second combustion mode is selected, while keeping the discharge energy of the spark plug 20 constant, the discharge time period is made longer than the discharge time period in the first combustion mode, and the discharge current value is made less than the discharge current value in the first combustion mode.

If the requested torque Treq is equal to or greater than the second threshold torque Tb, in step S10 the control apparatus 100 selects the third combustion mode as the combustion mode of the engine 1. In a case where the third combustion mode is selected, stoichiometric combustion is performed by using only fuel injection by the in-cylinder injection valve 26. At a time of switching from lean combustion to stoichiometric combustion, a plurality of control parameters relating to torque such as a degree of opening of the throttle valve, a degree of opening of the waste gate valve, valve timings, and the ignition timing are changed to values for stoichiometric combustion.

### [4. Operations of System]

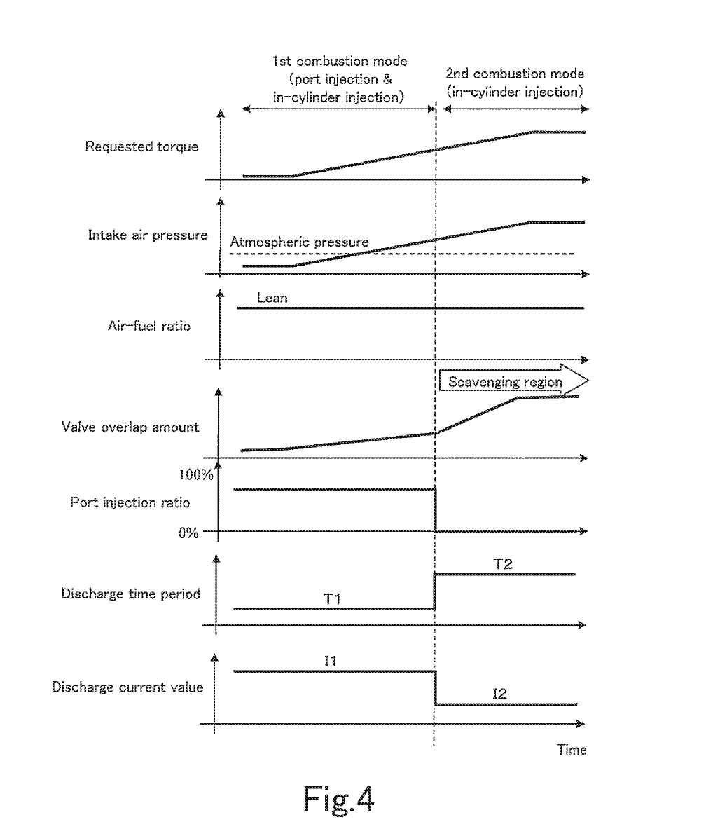

FIG. 4 is a time chart illustrating operations of the system according to the above described control logic. The time chart illustrates, in order from top to bottom, changes in accordance with time in the requested torque, the intake air pressure, the air-fuel ratio, the valve overlap amount, a port injection ratio, the discharge time period, and the discharge current value. The time chart starts from a state in which the engine 1 is operating in the combustion region of the first combustion mode. In the first combustion mode, lean combustion is performed by combined use of fuel injection by the port injection valve 24 and fuel injection by the in-cylinder injection valve 26. The port injection ratio that is a ratio of a fuel injection amount that is injected by the port injection valve 24 relative to the total fuel injection amount is set to a ratio between 50% and 100%. Further, in the first combustion mode, the discharge time period is set to T1 and the discharge current value is set to I1.

When a driver depresses the accelerator pedal and a requested torque that is calculated based on the degree of accelerator opening increases, the intake air pressure increases because the throttle valve 42 is opened in response thereto. Further, the valve overlap amount also increases due to the valve timing of the intake valve 14 being advanced in accordance with the increase in the requested torque. When the throttle valve 42 is eventually opened fully and the intake air pressure reaches the atmospheric pressure, the waste gate valve 68 is closed while keeping the throttle valve 42 fully open, and the intake air pressure is further increased by supercharging by the compressor 62.

Subsequently, when the requested torque reaches the maximum torque (first threshold torque) in a range in which blow-by of fuel due to scavenging does not occur, the combustion mode is switched from the first combustion mode to the second combustion mode. As a result of switching the combustion mode to the second combustion mode, only the intake stroke injection of the in-cylinder injection valve 26 is used, and hence the port injection ratio is made 0%. By this means, blow-by of fuel that is caused by scavenging is suppressed, and therefore in the second combustion mode the valve overlap amount is further increased in accordance with an increase in the requested torque to thereby actively utilize scavenging. Further, in the second combustion mode, the discharge time period is set to T2 that is a longer time period than the discharge time period T1 in the first combustion mode, and the discharge current value is set to I2 that is a smaller value than the discharge current value I1 in the first combustion mode. By this means, the ignitability is improved also with respect to an air-fuel mixture that is lean in fuel overall and in which the fuel concentration is uneven, and hence when switching from the first combustion mode to the second combustion mode it is not necessary to make the air-fuel ratio relatively richer in fuel in comparison to the first combustion mode in order to prevent misfiring.

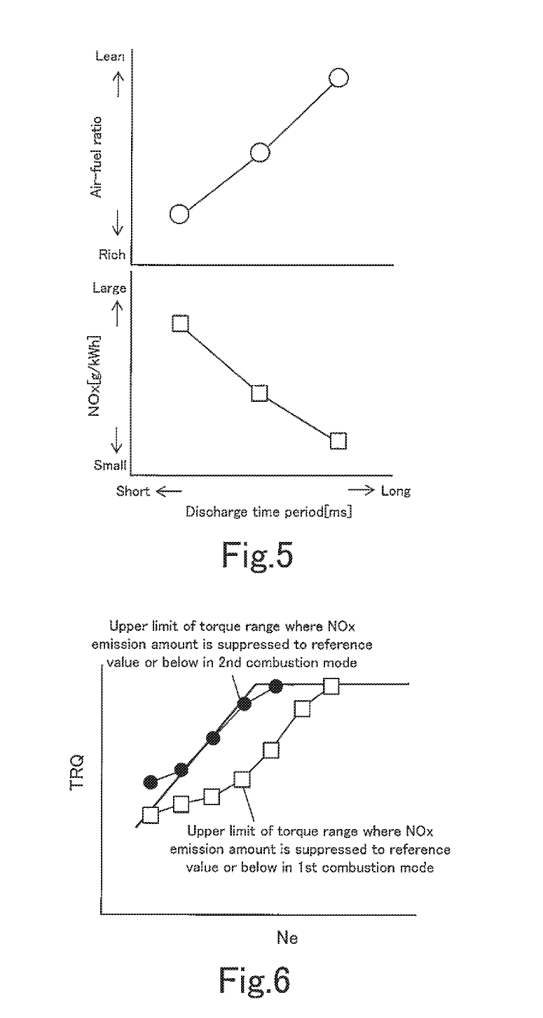

FIG. 5 is a view that illustrates a relation between a discharge time period in the second combustion mode, an ignitable air-fuel ratio and a NOx emissions amount. Based on this view it is found that although if the air-fuel ratio is made relatively richer in fuel the air-fuel mixture can be ignited even if the discharge time period is short, in such case the amount of NOx emissions increases. Further, based on this view it is also found that if the discharge time period is lengthened it is possible to suppress the NOx emissions amount to a low level since the ignitability can be ensured even if the air-fuel ratio is made relatively lean in fuel. Therefore, according to the above described control logic, by lengthening the discharge time period in accompaniment with switching from the first combustion mode to the second combustion mode, the switching from the first combustion mode to the second combustion mode can be performed while maintaining a low amount of NOx emissions.

FIG. 6 is a view illustrating the manner in which an upper limit torque of a range in which the amount of NOx emissions is suppressed to an amount that is less than or equal to a reference value changes depending on the engine speed. Operating points indicated by square marks in FIG. 6 are upper limit torques that can be realized in the first combustion mode, and operating points indicated by black circular marks are upper limit torques that can be realized in the second combustion mode. As shown in FIG. 6, by switching from the first combustion mode to the second combustion mode, a combustion region in which lean combustion is possible expands to the high torque side. Hence, according to the above described control logic, torque can be increased with a favorable response with respect to a requested torque while maintaining a low amount of NOx emissions.

### [5. Other Embodiment]

Although in the above described embodiment the present disclosure is applied to a control apparatus for an engine with a turbocharger, the present disclosure can also be applied to a control apparatus for an engine that includes a mechanical supercharger or an electric motor-driven supercharger. In addition, the present disclosure can also be applied to a control apparatus for a naturally aspirated engine.

1. A control apparatus for an internal combustion engine equipped with a port injection valve that injects fuel into an intake port, an in-cylinder injection valve that injects fuel directly into a combustion chamber, and a spark plug, the control apparatus comprising:
an electronic control unit configured to:
selectively execute a plurality of combustion modes that include a first combustion mode which realizes lean combustion with an air-fuel ratio that is leaner in fuel than a theoretical air-fuel ratio and which is constituted mainly by fuel injection by the port injection valve, and a second combustion mode which realizes the lean combustion by fuel injection in an intake stroke by the in-cylinder injection valve, and
make a discharge time period of the spark plug in the second combustion mode longer than a discharge time period in the first combustion mode.

2. The control apparatus for an internal combustion engine according to claim 1, wherein the electronic control unit is configured to make a discharge current value of the spark plug in the second combustion mode less than a discharge current value in the first combustion mode.

3. The control apparatus for an internal combustion engine according to claim 1, wherein:
the internal combustion engine is an internal combustion engine equipped with a supercharger, and
the electronic control unit is configured to increase a valve overlap amount between an intake valve and an exhaust valve to an amount that is larger than a valve overlap amount in the first combustion mode and also switch from the first combustion mode to the second combustion mode when a requested torque for the internal combustion engine is larger than a maximum torque that is generated in the first combustion mode.
